(19) United States
(12) Patent Application Publication
(10) Pub. No.: US 2025/0236702 A1
(43) Pub. Date: Jul. 24, 2025

(54) METHODS FOR ENHANCING THE MECHANICAL PROPERTIES OF POLYALKYLENE-BASED MATERIALS

(71) Applicant: Florida State University Research Foundation, Inc., Tallahassee, FL (US)

(72) Inventors: Rufina Alamo, Tallahassee, FL (US); Hamed Janani, Tallahassee, FL (US)

(21) Appl. No.: 19/023,771

(22) Filed: Jan. 16, 2025

Related U.S. Application Data
(60) Provisional application No. 63/623,430, filed on Jan. 22, 2024.

(51) Int. Cl. C08G 63/16; C08J 5/18

(52) U.S. Cl. CPC C08G 63/16; C08J 5/18; C08J 2367/02

(57) ABSTRACT

In accordance with the purpose(s) of the present disclosure, as embodied and broadly described herein, the disclosure, in one aspect, relates to polyalkylene-based polyesters crystallized in the hexagonal crystal form and methods for producing polyalkylene-based polyesters. The method can include preparing the polyalkylene-based polyester in a melt state and rapidly cooling the polyalkylene-based polyester in the melt state to produce the hexagonal crystal form of the polyalkylene-based polyester. The polyalkylene-based polyester produced in the hexagonal crystal form possess enhanced mechanical properties when compared to the same polyalkylene-based polyester in the orthorhombic crystal form.

### CROSS-REFERENCE TO RELATED APPLICATIONS

This application claims the benefit of and priority to co-pending U.S. Provisional Patent Application No. 63/623,430, filed on Jan. 22, 2024, the contents of which are incorporated by reference herein in their entireties.

### BACKGROUND

Controlling the formation of all possible crystalline structures plays a role in the manufacturing processes of crystalline polymers. In general, crystallization into more stable crystals endows harder, more rigid materials than a pseudo-crystalline phase. The latter tends to produce more ductile and transparent products. Hence, the possibility of self-assembly in different motifs endows a polymer material with properties that can be tailored for different applications.

Many commercial polymers crystallize in different polymorphs either by changing the rate of crystallization from the melt or by introducing defects in their chain structure. Typical examples are isotactic polypropylene and isotactic poly 1-butene. Conversely, except for n-alkanes and highly drawn fibers, polyethylene and linear low density polyethylenes (LLDPE) retain the orthorhombic crystallographic pattern under most common crystallization modes.

Polyethylene-like materials with functional moieties inserted at a precise equal backbone length have been featured as polymers of interest. Long-spaced aliphatic polyesters and polycarbonates possess crystallinity and mechanical properties akin to high-density polyethylene (HDPE). At the same time, the in-chain functional groups can act as predetermined break points and facilitate closed-loop chemical recycling via solvolysis to monomers under benign conditions. Prominent examples for a HDPE-like polycondensate are polyesters-18,18 and 2-18 (PE-18,18 and PE-2,18), which can be sourced from renewable octadecanedioic acid and its corresponding C₁₈-diol as recently shown. Also substituting the material's long-chain C₁₈-diol component with short-chain ethylene glycol (C₂-diol) in addition to chemical recyclability endows the resulting PE-2, 18 with relatively fast biodegradability. The material's desirable HDPE-like properties are preserved at the same time. There is a need for improved materials that have good mechanical properties, similar to HDPE, and are environmentally friendly, such as being biodegradable, and recyclable via closed-loop recycling.

### SUMMARY

In accordance with the purpose(s) of the present disclosure, as embodied and broadly described herein, the disclosure, in one aspect, relates to polyalkylene-based polyesters crystallized in the hexagonal crystal form and methods for producing polyalkylene-based polyesters. The method can include preparing the polyalkylene-based polyester in a melt state and rapidly cooling the polyalkylene-based polyester in the melt state to produce the hexagonal crystal form of the polyalkylene-based polyester. The polyalkylene-based polyester produced in the hexagonal crystal form possess enhanced mechanical properties when compared to the same polyalkylene-based polyester in the orthorhombic crystal form.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Further aspects of the present disclosure will be more readily appreciated upon review of the detailed description of its various embodiments, described below, when taken in conjunction with the accompanying drawings.

FIGS. 1A and 1B show WAXD patterns collected at room temperature of PE-2,18 and PE-3,18 specimens (˜0.12 mm thick), respectively, rapidly quenched or isothermally crystallized from the melt at the indicated temperatures. The pattern of linear polyethylene is added as reference.

FIG. 1C shows DSC thermograms on heating the PE-2,18 films of FIG. 1A at 10° C./min.

FIG. 1D shows FSC melting thermograms of PE-2,18 cooled at 2000 K/s from the melt and heated at the rates indicated.

FIGS. 2A-2C show FTIR spectra of PE-2,18 quenched or isothermally crystallized from the melt at the indicated temperatures with expanded regions of the FTIR spectra for CH₂ rocking (2B) and C—H bending (2C) modes.

FIG. 2D shows polarized optical micrographs taken at the indicated temperatures.

FIG. 3A-3B show Synchrotron X-ray patterns in the MAXS region (0.15 Å⁻¹<q<0.35 Å⁻¹), collected on heating PE-2,18 specimens in the orthorhombic (3A) and hexagonal (3B) forms.

FIG. 3C shows variation of q with temperature.

FIGS. 4A-4B show stress-strain deformation of PE-2,18 during deformation for orthorhombic PE-2,18 crystallized at 75° C. (4A) and hexagonal PE-2,18 quenched to room temperature (25° C.) (4B).

FIGS. 4C-4D show 1D WAXD patterns during deformation at different strains of orthorhombic (4C) and hexagonal (4D) specimens.

FIGS. 4E-4F show FTIR spectra of initial specimens and after break of orthorhombic (4E) and hexagonal (4F) specimens.

FIG. 5 shows DSC cooling and heating thermograms of PE-2,18 run at 10° C./min.

FIG. 6A shows spectra of PE-2,18 quenched or isothermally crystallized from the melt to the temperatures shown. The progression numbers are indicated.

FIG. 6B shows wavenumber vs phase angle dispersion curve of the progression bands in n-alkanes (line) and PE-2,18 (line with circles) corresponding to a continuous methylene sequence of 17 CH₂.

FIG. 7A shows FTIR spectra on heating PE-2,18 quenched from melt to 0° C.

FIG. 7B shows intensity of absorbance at 730 cm⁻¹ with increasing temperature.

FIG. 8 shows the number of repeating unit per lamellae thickness, estimated as I_{c}/d, vs crystallization temperature, where the lamellae thicknesses (I_{c}) was obtained by normalized 1-D correlation function (CF) analysis of SAXS (after Lorentz correction), and the ester-ester crystalline periodicity, d, was obtained from the layer peak that appears in the mid-angle of the X-ray scattering patterns.

FIGS. 9A-9B show WAXD peak deconvolution of samples quenched from melt to 0° C. and 75° C. for tensile experiments. The levels of crystallinities (X_{c}) are indicated.

FIGS. 10A-10B show FTIR spectra in the C—C bending region of orthorhombic (10A) and hexagonal (10B) PE-2,18 before and after stretching.

The drawings illustrate only example embodiments and are therefore not to be considered limiting of the scope described herein, as other equally effective embodiments are within the scope and spirit of this disclosure. The elements and features shown in the drawings are not necessarily drawn to scale, emphasis instead being placed upon clearly illustrating the principles of the embodiments. Additionally, certain dimensions may be exaggerated to help visually convey certain principles. In the drawings, similar reference numerals between figures designate like or corresponding, but not necessarily the same, elements.

### DETAILED DESCRIPTION

Before the present compounds, compositions, articles, devices, and/or methods are disclosed and described, it is to be understood that the aspects described below are not limited to specific compounds, synthetic methods, or uses as such may, of course, vary. It is also to be understood that the terminology used herein is for the purpose of describing particular aspects only and is not intended to be limiting.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions and Abbreviations

In describing and claiming the disclosed subject matter, the following terminology will be used in accordance with the definitions set forth below.

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a solvent” includes, but are not limited to, mixtures or combinations of two or more such solvents, and the like.

It should be noted that ratios, concentrations, amounts, rates, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed and “about 5 to about 15” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

Disclosed are the components to be used to prepare the compositions disclosed herein as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

As used herein, the terms “optional” or “optionally” means that the subsequently described event or circumstance can or cannot occur, and that the description includes instances where said event or circumstance and instances where it does not.

As used herein, the term “alkylene” is defined as —(CH₂)ₓ—, where x is an integer from 1 to 10.

As used herein, the term “polyalkylene” is a polymer that includes two or more alkylene groups as defined herein.

As used herein, the term “polyalkylene-based polyester” is a polymer that includes a plurality of alkylene groups and ester groups.

### Crystallized Polyalkylene-Based Polyesters and Methods for Crystallizaiton

It has been discovered that cooling polyalkylene-based polyesters in the melt state under certain conditions can modify the physical properties of the resulting crystallized polyalkylene-based polyester. For example, the polyalkylene-based polyesters crystallized by the methods described herein can impart improved or enhanced tensile properties to the crystallized polymer in comparison to polyalkylene-based polyesters crystallized by other methods.

In one aspect, the polyalkylene-based polyester is an unbranched, aliphatic polyester. In another aspect, the polyalkylene-based polyesters can include repeat units having the structure I:

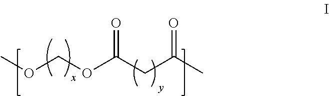

where x can be 2 or 3 and y can be an integer greater than 10. The polyalkylene-based polyester can have a number average molecular weight greater than 30 kg/mol. In one aspect, the polyalkylene-based polyester is in a hexagonal crystal form. In another aspect, x is 2. In another aspect, y is an integer from 12 to 50. In one aspect, x is 2 and y is 16, which is referred to herein as polyester-2,18 or PE-2,18. In another aspect, x is 3 and y is 16, which is referred to herein as polyester-3,18 or PE-3,18. In general, polyalkylene-based polyesters having repeat units of structure I can be labelled as polyester-x,y+2 or PE-x,y+2. In one aspect, the polyalkylene-based polyester can have a number average molecular weight of about 30 kg/mol to about 500 kg/mol, as measured by GPC vs. polystyrene, or about 30 kg/mol, 50 kg/mol, 100 kg/mol, 150 kg/mol, 200 kg/mol, 250 kg/mol, 300 kg/mol, 350 kg/mol, 400 kg/mol, 450 kg/mol, or 500 kg/mol, where any value can be a lower and upper endpoint of a range (e.g., 30 kg/mol to 200 kg/mol).

In one aspect, the methods described herein for producing or crystallizing the polyalkylene-based polyesters include the rapid cooling or quenching of a polyalkylene-based polyester in a melt state. In one aspect, the methods include: preparing the polyalkylene-based polyester in a melt state and cooling the polyalkylene-based polyester in the melt state at a rate of greater than 80° C. per minute. Prior to cooling or quenching, the polyalkylene-based polyester is converted to a melt state using techniques known in the art. A polymer in its melt state has been heated to or above its melting point to form a viscous liquid. In one aspect, the polyalkylene-based polyester is heated from about 30° C. to about 40° C. above its melting point. The polyalkylene-based polyester in the melt state can be cooled at a rate of greater than 80° C. per minute to about 1000° C. per minute, or about 80° C./min, 100° C./min, 200° C./min, 300° C./min, 400° C./min, 500° C./min, 600° C./min, 700° C./min, 800° C./min, 900° C./min, or 1000° C./min, where any value can be a lower and upper endpoint of a range (e.g., 80° C./min to 500° C./min). In another aspect, the polyalkylene-based polyester is cooled from a melt state to a temperature of less than about 60° C. In a further aspect, the polyalkylene-based polyester is cooled from a melt state to a temperature of about 0° C. to about 60° C. In another aspect, the polyalkylene-based polyester is cooled from a melt state to a temperature that is at least 45° C. below the polymer's crystallization temperature.

After cooling and crystallizing, the crystallized polyalkylene-based polyester can be heated, optionally via fast melt-recrystallization. This heating can induce a melting and recrystallization into a different form of the crystal, e.g., going from a hexagonal form to an orthorhombic form. For example, when the polyalkylene-based polyester is PE-2,18, this recrystallization can occur after first melt at about 60° C. to about 70° C.

The polyalkylene-based polyesters or films including the polyalkylene-based polyesters can be components of different articles. The polyalkylene-based polyester films can have a thickness of about 0.05 mm to about 0.20 mm or 0.05 mm, 0.10 mm, 0.15 mm, or 0.20 mm, where any value can be a lower and upper endpoint of a range (e.g., 0.10 mm to 0.15 mm). In one aspect, the article can include a plastic, such as those used in packaging goods. The plastic can include plastic bags, plastic wraps, single-layer packaging plastics, multi-layer packaging plastics, single-use disposable plastics, and the like. Single-use disposable plastics can include, but are not limited to, plastic cutlery, plastic tableware (such as plastic plates, plastic bowls, or plastic cups), beverage straws, disposable non-woven fabrics, and the like.

In one aspect, the polyalkylene-based polyester is a polycondensation product of dialkyl ester and an alkylene glycol. In one method of polycondensation, a mixture including a dialkyl ester (e.g., 1,18-dimethyl octadecanedioate), an alkylene glycol (e.g., ethylene glycol), and, optionally, a catalyst is heated and stirred at least until oligomerization begins. Once oligomerization has begun, the mixture can be put under a vacuum. The mixture can be left under vacuum, stirred, and kept at an elevated temperature (e.g., 150° C. to 200° C.) as polymerization occurs. In a further aspect, the mixture is allowed to polymerize for about 10 hours to about 24 hours. The temperature of the mixture can be kept constant throughout the polymerization step, increased, or decreased as needed. Examples of catalysts that can be used include dibutyltin oxide and Ti(OⁿBu)₄.

### Characteristics of the Crystallized Polyalkylene-Based Polyesters

The polyalkylene-based polyester may crystallize from the melt in a hexagonal form or an orthorhombic form. In one aspect, the polyester crystallized from its melt state via the rapid cooling method is in a phase that is different from the phase of an equivalent polyester crystallized via a different method, such as a slower rate of cooling (e.g., cooled from the melt at a rate of less than 80° C. per minute). In one aspect, the polyalkylene-based polyester crystallized via the rapid cooling method is in the hexagonal phase and the equivalent polyalkylene-based polyester crystallized via a different method is the orthorhombic phase. The hexagonal form or hexagonal phase can be characterized by a single wide angle x-ray diffraction reflection at a q value of approximately 1.5 Å⁻¹.

The crystallized polyalkylene-based polyester discussed herein can have a degree of crystallinity of about 40% to about 90% or about 40%, 50%, 60%, 70%, 80%, or 90%, where any value can be a lower and upper endpoint of a range (e.g., 50% to 80%). In further aspects, the crystallized polymer can have a degree of crystallinity of about 55%.

In one aspect, the polyalkylene-based polyester crystallized in a hexagonal phase can be characterized by having superior mechanical or tensile properties, such as in comparison to an equivalent polyalkylene-based polyester crystallized in an orthorhombic phase. Tensile properties of a crystallized polymer such as the polyalkylene-based polyesters can be measured using various strategies. In one aspect, thin films of the polyalkylene-based polyesters can be subjected to stretching at constant deformation rates. An engineering stress (σ)-strain (ε) curve can be derived from the force-displacement data. Using the curve, an elastic modulus (E) value can be calculated from the curve's slope within the linear elastic region and a yield stress (σ_{y}) value can be obtained from the point where dσ/dε=0. Strain-hardening intensity or strain-hardness can be calculated as the difference between the yield stress and the ultimate stress at break (σ_{b}), i.e., σ_{b}−σ_{y}.

The crystallized polyalkylene-based polyesters can have an elastic modulus of about 350 MPa to about 800 MPa or about 350 MPa, 400 MPa, 450 MPa, 500 MPa, 550 MPa, 600 MPa, 650 MPa, 700 MPa, 750 MPa, or 800 MPa, where any value can be a lower and upper endpoint of a range (e.g., 400 MPa to 425 MPa). In further aspects, the crystallized polyalkylene-based polyesters can have a yield stress of about 20 MPa to about 35 MPa or about 20 MPa, 22 MPa, 25 MPa, 27 MPa, 30 MPa, 32 MPa, or 35 MPa, where any value can be a lower and upper endpoint of a range (e.g., 25 MPa to 30 MPa). In further aspects, the crystallized polyalkylene-based polyesters can have an ultimate stress at break of about 25 MPa to about 40 MPa or 25 MPa, 27 MPa, 30 MPa, 33 MPa, 35 MPa, or 40 MPa, where any value can be a lower and upper endpoint of a range (e.g., 30 MPa to 40 MPa). In further aspects, the crystallized polyalkylene-based polyesters can have a strain-hardness of about 2 MPa to about 20 MPa or about 2 MPa, 5 MPa, 8 MPa, 12 MPa, 15 MPa, 18 MPa, or 20 MPa, where any value can be a lower and upper endpoint of a range (e.g., 5 MPa to 20 MPa). In yet further aspects, the crystallized polyalkylene-based polyesters can have an elongation at break of about 400% to about 600% or about 400%, 425%, 450%, 475%, 500%, 525%, 550%, 575% or 600%, where any value can be a lower and upper endpoint of a range (e.g., 400% to 500%). Further details and examples of measuring tensile properties of crystallized polymers can be found in the Examples.

The tensile or mechanical properties of a polyalkylene-based polyester crystallized in the hexagonal phase or form can be superior to the properties of an equivalent polyalkylene-based polyester crystallized in the orthorhombic phase or form. In one aspect, the hexagonal phase polyalkylene-based polyester can have a larger ultimate stress at break value than the equivalent orthorhombic phase polyalkylene-based polyester. In a further aspect, the hexagonal phase polyalkylene-based polyester can have an ultimate stress at break value that is at least 1.15 times larger than the ultimate stress at break value of the equivalent orthorhombic phase polyalkylene-based polyester. In another aspect, the hexagonal phase polyalkylene-based polyester can have a larger elongation at break value than the equivalent orthorhombic phase polyalkylene-based polyester. In a further aspect, the hexagonal phase polyalkylene-based polyester can have an elongation at break value that is at least 1.5 times larger than the elongation at break value of the equivalent orthorhombic phase polyalkylene-based polyester. In yet another aspect, the hexagonal phase polyalkylene-based polyester can have a larger strain-hardness value than the equivalent orthorhombic phase polyalkylene-based polyester. In a further aspect, the hexagonal phase polyalkylene-based polyester can have a strain-hardness value that is at least two times larger than the strain-hardness value of the equivalent orthorhombic phase polyalkylene-based polyester.

### Aspects

Aspect 1. A polyalkylene-based polyester comprising the repeat units having the structure I

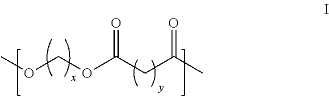

wherein
   x is 2 or 3, and y is an integer greater than 10;
   the polyalkylene-based polyester has a number average molecular weight greater than 30 kg/mol; and
   the polyalkylene-based polyester is crystallized in hexagonal crystal form.
      Aspect 2. A polyalkylene-based polyester comprising the repeat units having the structure I

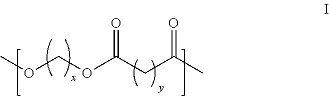

wherein
   x is 2 or 3, and y is an integer greater than 10;
   the polyalkylene-based polyester has a number average molecular weight greater than 30 kg/mol; and
   the polyalkylene-based polyester is in hexagonal crystal form,
wherein the polyalkylene-based polyester is produced by the method comprising
(a) preparing the polyalkylene-based polyester in a melt state, and
(b) cooling the polyalkylene-based polyester in the melt state at a rate of greater than 80° C. per minute to a temperature below 60° C.
   Aspect 3. The method of Aspect 2, wherein preparing the polyalkylene-based polyester in a melt state comprises heating the polyalkylene-based polyester to from about 30° C. to about 40° C. above the melting point of the polyalkylene-based polyester.
   Aspect 4. The method of Aspect 2, wherein the polyalkylene-based polyester in the melt state is cooled at a rate of greater than 80° C. per minute to about 500° C. per minute.
   Aspect 5. The method of Aspect 2, wherein the polyalkylene-based polyester in the melt state is cooled to a temperature of less than about 60° C.
   Aspect 6. The method of Aspect 2, wherein the polyalkylene-based polyester in the melt state is cooled to a temperature of from about 0° C. to about 60° C.
   Aspect 7. The polyalkylene-based polyester of Aspect 1 or 2, wherein y is an integer from 12 to 50.
   Aspect 8. The polyalkylene-based polyester of Aspect 1 or 2, wherein y is 16.
   Aspect 9. The polyalkylene-based polyester of any one of Aspects 1-8, wherein the polyalkylene-based polyester has a number average molecular weight of about 30 kg/mol to about 500 kg/mol.
   Aspect 10. The polyalkylene-based polyester of any one of Aspects 1-8, wherein the polyalkylene-based polyester has a number average molecular weight of about 30 kg/mol to about 200 kg/mol.
   Aspect 11. The polyalkylene-based polyester of any one of Aspects 1-10, wherein the crystallized polyalkylene-based polyester has a degree of crystallinity of about 40% to about 90%.
   Aspect 12. The polyalkylene-based polyester of any one of Aspects 1-10, wherein the crystallized polyalkylene-based polyester has an elastic modulus of about 350 MPa to about 800 MPa.
   Aspect 13. The polyalkylene-based polyester of any one of Aspects 1-10, wherein the crystallized polyalkylene-based polyester has a yield stress of about 20 MPa to about 35 MPa.
   Aspect 14. The polyalkylene-based polyester of any one of Aspects 1-10, wherein the crystallized polyalkylene-based polyester has an ultimate stress at break of about 30 MPa to about 40 MPa.
   Aspect 15. The polyalkylene-based polyester of any one of Aspects 1-10, wherein the crystallized polyalkylene-based polyester has a strain-hardness of about 5 MPa to about 20 MPa.
   Aspect 16. The polyalkylene-based polyester of any one of Aspects 1-10, wherein the crystallized polyalkylene-based polyester has an elongation at break from about 400% to about 600%
   Aspect 17. The polyalkylene-based polyester of any one of Aspects 1-16, wherein the crystallized polyalkylene-based polyester has a larger ultimate stress at break value than an equivalent polyalkylene-based polyester crystallized in orthorhombic form.
   Aspect 18. The polyalkylene-based polyester of any one of Aspects 1-16, wherein the crystallized polyalkylene-based polyester has a larger elongation at break than an equivalent polyalkylene-based polyester crystallized in orthorhombic form.
   Aspect 19. The polyalkylene-based polyester of any one of Aspects 1-16, wherein the crystallized polyalkylene-based polyester has a larger strain hardening value than an equivalent polyalkylene-based polyester crystallized in orthorhombic form.
   Aspect 20. A film or membrane comprising the polyalkylene-based polyester of any one of Aspects 1-19.
   Aspect 21. The film or membrane of Aspect 20, wherein the film is a component of an article.
   Aspect 22. An article comprising the polyalkylene-based polyester of any one of Aspects 1-19.
   Aspect 23. The article of Aspect 22, wherein the article is a plastic used in packaging goods.
   Aspect 24. The article of Aspect 22, wherein the plastic is a plastic bag, plastic wrap, single-use plastic, non-woven fabrics, single-layer packaging plastic, or multi-layer packaging plastic.

### EXAMPLES

Now having described the embodiments of the disclosure, in general, the examples describe some additional embodiments. While embodiments of the present disclosure are described in connection with the example and the corresponding text and figures, there is no intent to limit embodiments of the disclosure to these descriptions. On the contrary, the intent is to cover all alternatives, modifications, and equivalents included within the spirit and scope of embodiments of the present disclosure.

### Materials and Methods

### Material Synthesis

All chemicals were used as received without further purification. 1,18-octadecanedioic acid was purchased from Elevance Renewable Sciences Inc. 1,18-Dimethyl octadecanedioate and PE-2,18 were prepared as reported previously.^{19,20} Dibutyltin oxide (for synthesis) was purchased from Sigma Aldrich. Xylene (isomeric mixture, ≥99%) and ethylene glycol (≥99.5%) were purchased from Carl Roth. 2-Propanol (≥99.7%) was purchased from VWR. Deuterated solvents for NMR spectroscopy were purchased from Eurisotop and dried over molecular sieves from Riedel de-Haën (0.4 nm).

### Characterizations

Nuclear magnetic resonance (NMR) spectra were recorded on a Bruker Avance III HD 400 spectrometer. Chemical shifts were referenced to the resonance of the solvent (residual proton resonances for 1H spectra). Mestrenova software by Mestrelab Research S.L. (version 14.1.2) was used for data evaluation. The degree of polymerization, DPₙ, and the number-average molecular weight, M_{n,NMR}, of PE-2,18 were determined via end group analysis of 1H NMR spectra (400 MHZ, C₂D₂Cl₄, 383 K). For the calculations, the integral of the end group resonance, EH (—CH₂—OH, σ=3.84 ppm), and the integral of a backbone resonance, B (—CH₂—C(O)—O—CH₂—, σ=4.31 ppm) were used. The degree of polymerization, DPₙ, of PE-2,18 was determined using Equation 1.

$${DP}_{n} = \frac{\int B}{\frac{1}{2} \int {E}_{H}} + 1 \qquad Equation 1$$

On basis of the DPₙ, the molecular weight, M_{n,NMR}, was calculated according to Equation 2. The molar mass of the repeat unit of PE-2,18, M_{RU-2,18}, equals 340.5 g mol⁻¹.

$${M}_{n , NMR} = DPn \cdot \frac{{M}_{RU - 2 , 18}}{2} \qquad Equation 2$$

Molecular weights of polymers were determined by gel permeation chromatography (GPC) in chloroform at 35° C. on a PSS SECcurity² instrument, equipped with PSS SDV linear M columns (2×30 cm, additional guard column) and a refractive index detector (PSS SECcurity² RI). A standard flow rate of 1 mL min-1 was used. Molecular weights were determined versus narrow polystyrene standards (software: PSS WinGPC, version 8.32).

TABLE 1
Molecular weight data from GPC and H¹ NMR.

| | Mₙ (kDa) | Mₙ (kDa) | M_{w} (kDa) | PDI |
|---|---|---|---|---|
| | ¹H NMR | GPC | GPC | GPC |
| PE-2,18 | 21 | 47 | 118 | 2.5 |

Thermal analysis, X-ray analysis, Fourier Transform Infrared Spectroscopy (FTIR), and tensile stress-strain tests were employed to investigate the crystallization and melting behavior, as well as structure and mechanical properties of the samples.

For thermal analysis, a TA Q2000 differential scanning calorimeter (DSC) equipped with an RC900 intracooler was used. Dynamic crystallization involved heating to 130° C., followed by cooling to −80° C. and reheating to 130° C., all at 10° C./min. Isothermal crystallization included melting at 130° C., cooling to the desired crystallization temperature (T_{c}), holding at T_{c} until completion of the exotherm, and subsequent reheating to 130° C. for endotherm observation. High undercooling crystallization (T_{c}<70° C.) was achieved through two methods: rapid cooling in a water bath following hot press melting or utilizing a Mettler Toledo Flash DSC 1 Fast-Scanning calorimeter (FSC) coupled with a Huber TC100 intracooler. Before introducing approximately 50 ng of the sample, the FSC sensor was appropriately conditioned and temperature-calibrated across a temperature range from −50 to 150° C. The sample placement was optimized using a Leica M60 microscope and a CCD IC90 camera.

X-ray patterns of specimens isothermally crystallized in the DSC or rapidly quenched in ice water or in temperature-controlled water baths were obtained at room temperature using a Bruker Nanostar diffractometer equipped with an Incoatec microfocus (IS) X-ray source, which simultaneously collected small-angle X-ray scattering (SAXS) and wide-angle X-ray scattering (WAXS) diffractograms.

X-ray patterns collected in-situ during heating at 1° C./min at beamline 5ID of the Advanced Photon Source (APS) at Argonne National Laboratory in a Linkam Scientific Instruments Ltd., UK. X-ray patterns, at an exposure time of 0.5 seconds, were recorded continuously throughout the heating cycle until sample is melted.

FTIR spectra were acquired in ATR mode using a Thermo Scientific Nicolet 6700 spectrometer equipped with a TE cooled DTGS TEC detector over a wavenumber range of 400 cm⁻¹ to 4000 cm⁻¹ with a 2 cm⁻¹ resolution. Using a Linkam hot stage equipped with ZnSe windows, real-time FTIR spectra were also collected in transmission mode during heating at 2° C./min specimens in the orthorhombic (Q 75 C) or hexagonal (Q 0 C) forms. The supermolecular morphology was investigated using an Olympus BX51 polarized optical microscope fitted with an Olympus DP72 fast digital camera and the Linkam hot stage for temperature control. For the microscopy work, a thin film specimen of PE-2,18 was sandwiched between two glass cover slides.

Tensile properties and structural transitions were analyzed in ˜100 μm thick films of PE 2,18 prepared by quenching from melt to temperature-controlled water baths at 25° C. and 75° C. Dumbbell-shaped samples for uniaxial tensile deformation were obtained from the film using a metal puncher. The neck thickness of the samples was 2 mm, the gauge length was 7 mm, and the overall thickness was 0.1 mm. The samples were subjected to stretching at a constant deformation rate of 0.5 mm/min using an ARES-G2 TA instrument in extension deformation mode. The instrument utilized a Brushless DC drive motor with a maximum torque of 800 mN·m. An Optical Encoder was employed for displacement sensing. The engineering stress (σ)-strain (ε) curve was derived from the force-displacement data. The elastic modulus (E) was determined from the slope of the strain-stress curve within the linear elastic region. The yield stress (σ_{y}) was determined at the point where dσ/dε=0, and the intensity of strain-hardening was calculated as the difference between the yield stress and the ultimate stress at break (σ_{b}), i.e. σ_{b}−σ_{y}. The tensile data recorded were average values from 3-4 specimens for each sample. The only exception was the value for the deformation at break of the orthorhombic specimen. Of the four orthorhombic specimens tested, three slipped out of the grips or broke in the middle of the deformation from voids. Hence although the modulus and yield stress are average data, the deformation at break listed in Table 2 (280%) is for one dumbbell specimen.

To study structural changes during deformation, the Bruker Nanostar diffractometer was equipped with a custom stretching stage. SAXS/WAXS patterns were collected at various elongations of the same dumbbell specimens. 2D WAXS patterns were captured using a Fuji Film detector plate and scanned with a Fuji FLA-7000 scanner. The Dumbbell-shaped samples were stretched to the desired elongation, and the corresponding pattern was collected. This process was repeated until the samples reached the breaking point. Since the stretching was gradual and the deformation rate was significantly lower than in the tensile test, the samples achieved higher elongations (up to 550%) compared to those from the stress-strain curve.

For PE 2,18 samples crystallized at 0° C. (in the hexagonal form), the 2D WAXS patterns were collected at 0%, 30%, 190%, 300%, and 550% elongations. For PE samples crystallized at 75° C. (in the orthorhombic form), the 2D WAXS patterns were obtained at 0%, 134%, 300%, and 420% elongations. We also collected the WAXS patterns of the samples after break in the stretching device.

Progression Modes in FTIR Spectra of n-Alkanes and PE-2,18:

Infrared spectroscopy has been highly instrumental in analyzing the conformation of crystalline continuous methylene sequences, based on rocking, twisting and wagging vibrational bands for a large number of systems, including n-alkanes. Snyder successfully associated the frequencies of methylene rocking, twisting and wagging, as well as C—C stretching modes to the phase difference (ϕ) in motion between adjacent methylene groups of n-alkanes.^{43,43} In brief, for a particular vibration of a system of m coupled oscillators, i.e. the methylene sequence of the n-alkane molecule, the solution of the secular equation gives,

$${λ}_{( K , m )} = {a}_{o} + 2 {\sum }_{i = 1} {a}_{i} cos i {ϕ}_{( k , m )} \qquad Equation 3$$

Where a₀, a₁, a₂ are the eigenvectors or coefficients of the matrix,⁴² and the phase angle is given by,

$${ϕ}_{( K , m )} = \frac{K π}{m + 1} ( K = 1 , 2 , 3 , … m ) \qquad Equation 4$$

The integer K characterizes each normal mode; for infrared active vibrations even K modes are forbidden.⁴² Frequency versus phase angle for progression modes of n-alkanes in the methylene rocking, twisting, and wagging regions are well-established dispersion curves independent of chain length, as predicted by eq. 2.⁴³ Hence, if a progression of absorbances in the rocking region follows the dictates of the n-paraffinic all-trans packing, identifying the sequence length accounts merely to counting progression bands starting from the lowest well-known 720 cm⁻¹ absorbance (K=1). The phase angle, ϕ_{(K,m)} corresponding to a given K mode is calculated with Equation 4. Albeit simple, the coupled oscillator model provides a useful method to test periodic n-alkane-like self-assembled structures. For example, adherence to the n-alkane dispersion curve of the progression of infrared methylene rocking and wagging bands has been used successfully to identify the same all-trans packing of methylene sequences of myristate salts that crystallize in two different polymorphs.⁴⁴ Trans packing of methylene sequences and conformational disorder has been extracted for other molecules as well from the analysis of progression bands in reference to the n-alkane behavior.⁴⁴

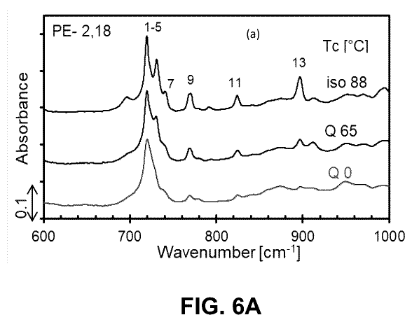

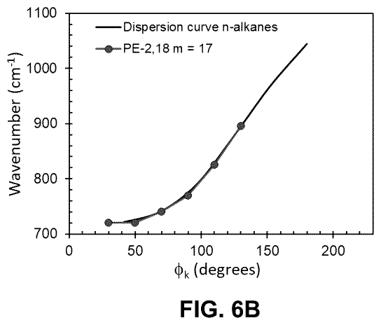

The set of progression bands identified by integer odd numbers in the spectra of FIG. 6A are equivalent to the all-trans vibrational sequence of n-alkane C₁₉H₄₀ which corresponds closely to the longest CH₂ sequence of PE-2,18. The progression bands fall on the n-alkane frequency vs phase angle dispersion curve (see FIG. 6B), hence giving strong evidence for the all-trans conformation of the methylene sequences of PE-2,18 in the orthorhombic subcell (T_{c}>45° C.).

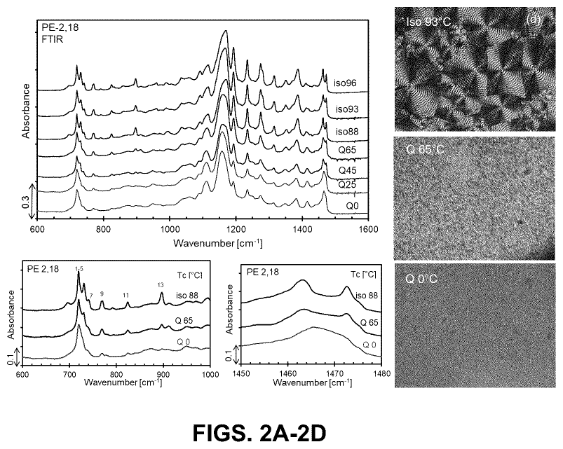

In the hexagonal form (spectrum of specimen Q 0° C. in FIG. 2B), progression modes are also present, but their intensity very weak. The presence of these modes in fast quenched PE-2,18 most probably indicates that some of the orthorhombic structure develops with the hexagonal form during fast cooling.

### DISCUSSION

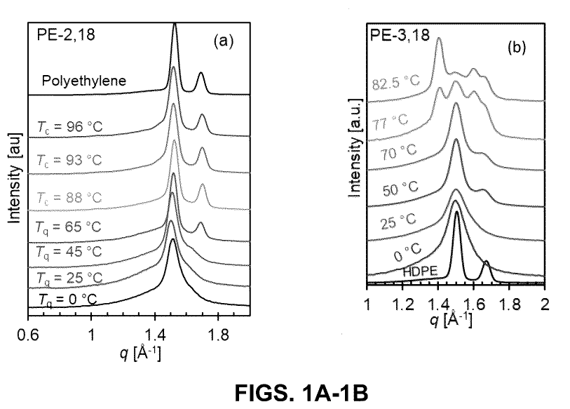

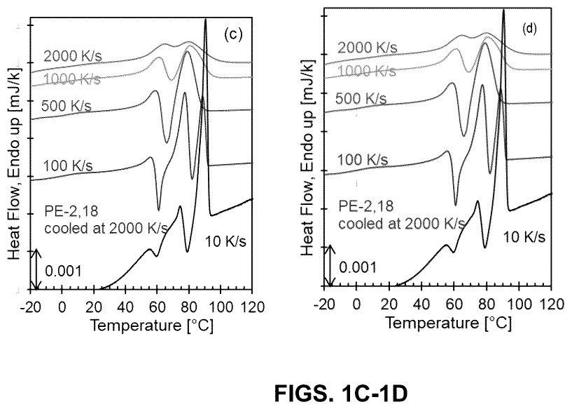

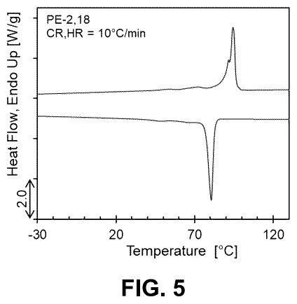

The PE-2,18 system studied has Mₙ=47K g/mol measured by GPC vs. polystyrene (Ð=2.5), and crystallization and melting temperatures of 80.6° C. and 94.5° C. respectively, both measured by DSC at 10° C./min (FIG. 5). The corresponding heat of fusion is 124 J/g. As shown by the WAXD patterns of FIG. 1A, isothermally crystallized at temperatures (T_{c}) above 65° C., PE-2,18 displays a subcell structure equivalent to the orthorhombic packing of linear polyethylene. The latter is indicated by the two major reflections at q=1.5 and 1.7 Å⁻¹ corresponding respectively to the (110) and (200) planes of the orthorhombic unit cell. When rapidly cooled at temperatures below 65° C., only the reflection at q=1.5 Å⁻¹ remains. This relatively sharp spacing at 4.20 Å is equivalent to single reflections observed at 4.24 Å in n-alkanes and in precision polyethylenes with acid pendant groups placed on every 21^{st} carbon, both attributed to a hexagonal packing.^{15,23} Hence, at least the subcell of PE-2,18, which is mainly characterized by the three-dimensional packing of the 18 CH₂ units, undergoes a change from orthorhombic to hexagonal with increasing undercooling. Peak deconvolution of the WAXD patterns of FIG. 1A leads to degrees of crystallinity of ˜ 55% for rapidly quenched hexagonal specimens, ˜56% for mildly quenched (Q 65° C.), and ˜65% for isothermally crystallized orthorhombic samples.

Polymorphism as a function of increasing temperature was found in precision polyethylene-like materials with halogens,¹⁸ in long-spaced polyacetals,^{24,25} and recently, in long-short aliphatic polyesters with pendant OH and CH₃ groups in the repeating segment of the chiral diacid monomer.²⁶ The polyesters of the latter study included polycondensates from S(−) methyl succinic acid or L(−) maleic acid and n-methylene diols (n=6-16 even numbered) as well as the unbranched aliphatic polyester PE-12,4. Only the polyesters with side branches showed a temperature induced crystal transition from hexagonal (Form II) at low temperature to a triclinic-like (Form I) structure in the high range of temperatures. The unbranched polyester remained orthorhombic during heating and cooling or by changing undercooling under isothermal crystallization. Hence, the polymorphic transition was attributed to the presence of OH and CH₃ side groups in the polyester chain. To the best of our knowledge, temperature induced polymorphism just as that shown by PE-2,18 in FIG. 1A, has not been observed earlier in long spaced aliphatic polyesters (LSAPEs), or those spaced by >14 CH₂.^{27,28} The polymorphism of PE-2,18 contrasts with the behavior of symmetric LSAPEs, including PE-18,18, which on cooling from the melt crystallize in the orthorhombic phase independent of the rate or mode of cooling.^{29,30} It also contrasts with other congeneric aliphatic polyesters of the PE-2, Y type such as polyethylene (brassylate) (a polyester equivalent to PE-2,13), which likewise maintains the orthorhombic structure independent of the crystallization temperature.^{31,32} Hence, neither the presence of side groups nor the increased ester functionality of PE-2,18 compared with PE-18, 18 are the determining factors for the change in crystal packing with temperature.

We have observed that PE-2,18 specimens in the hexagonal form are stable. They maintain the same structure while stored at room temperature for over a month. However, on heating, they undergo reorganizations as shown in the DSC thermograms of FIG. 1C. The shallow broad endotherm at 50-55° C. is in a temperature region where in FIG. 1B we see the change from the hexagonal to an orthorhombic-like pattern. Hence, we attribute this endotherm to melting of the initial hexagonal crystals, and recrystallization in the 60-70° C. range to crystals in the orthorhombic phase, which further melt at 76° C. and recrystallize into thicker crystallites that finally melt at a constant 95° C. Conversely, more stable orthorhombic crystals formed at T_{c}>65° C. lack the broad endotherm at ˜50° C., and on heating melt at increasingly higher temperatures (92-101° C.), as expected for crystallizations carried out at progressively lower undercooling. The small endotherm at 90° C. is melting of thinner crystals formed on quenching to room temperature after the isothermal crystallization. Recrystallization during heating of hexagonal crystals formed under fast cooling is confirmed by fast scanning calorimetry (FIG. 1D). The initial hexagonal crystals formed on cooling at 2000 K/s first melt at 55° C. and recrystallize at 60° C. as indicated by the subsequent exotherm.

Conformational and morphological differences between orthorhombic and hexagonal PE-2,18 crystals are given by representative infrared spectra and polarized optical micrographs. Below the full FTIR spectra (FIG. 2A) are expanded wavenumber regions for the CH₂ rocking-twisting (600-1000 cm⁻¹) and the CH bending (1450-1480 cm⁻¹) modes where we observe major differences between quenched and isothermally crystallized samples (FIGS. 2B and c). Specimens crystallized in the orthorhombic-like pattern show the expected splitting of the major CH₂ rocking mode giving absorbances at 720 and 730 cm⁻¹ due to non-equivalent vibrational correlation between the two chains of the unit cell of orthorhombic polyethylene. In the hexagonal form (spectra of specimens quenched at <45° C.), the characteristic splitting of the 720 cm⁻¹ band vanishes. This loss of band splitting was also found in the transition from orthorhombic to hexagonal phase of C₂₉H₆₀ during heating, and in the hexagonal phase of n-C₁₉H₄₀, which is an analog for the longest staggered CH₂ sequences of PE-2, 18.^{6,33} Moreover, in the bending region (FIG. 2C), the decrease of the 1463 and 1473 cm⁻¹ trans crystalline bands at the expense of developing intensity in the 1466 cm⁻¹ gauche-rich region, mimics the behavior of the orthorhombic to a conformationally disordered hexagonal transition on heating ultra drawn polyethylene fibers.⁶ From the latter we deduce that there is likely conformational disorder in the crystalline CH₂ sequences of the hexagonal phase of PE-2,18.

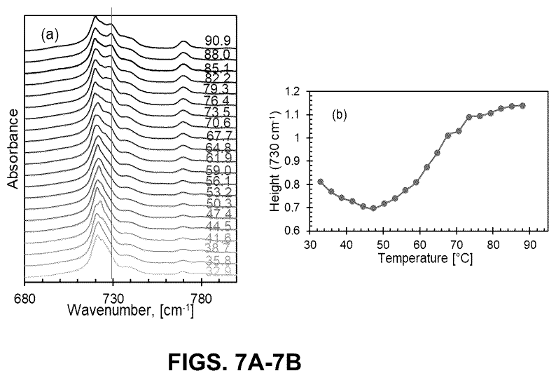

The thermally induced transformation on heating via fast melt-recrystallization from hexagonal PE-2,18 to orthorhombic CH₂ packing inferred by the DSC and FSC data is clearly observed in FTIR spectra collected in-situ on heating specimens initially quenched to 0° C. (FIGS. 7A and 7B). The rocking mode at 720 cm⁻¹ is a singlet prior to melting of the hexagonal phase and starts splitting at about 60° C. when the hexagonal recrystallizes into the orthorhombic crystal. The polymorphic change can be quantified by following the intensity of the 730 cm⁻¹ band with increasing temperature. The intensity of this band starts to increase at ˜60° C. Another feature observed in the FTIR spectra collected on heating is the disappearance of the 780 cm⁻¹ band at T>70° C. which is likely associated with the disordered hexagonal packing.

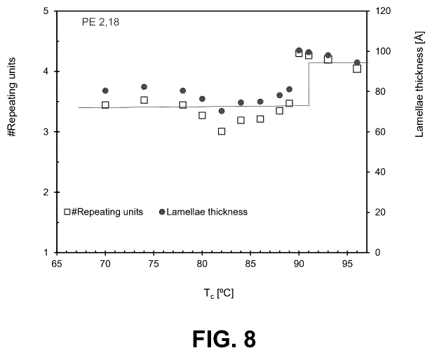

The temperature-induced structural change also reflects a change in the supermolecular morphology of PE-2,18 as viewed by polarized optical microscopy (FIG. 2D). Specimens Q 0° C. or rapidly crystallized in the hexagonal phase display a finer, densely nucleated morphology. Within the orthorhombic-like region of the phase diagram (T_{c}≥60° C.), PE-2,18 undergoes a second morphological change from highly nucleated axialites (60° C.<Tc<90° C.) to banded spherulites at Tc≥91° C. In analogy to the behavior of other long-spaced polyesters, we associate the high temperature morphological change with a transition between quantized crystal thicknesses.^{30,31} Indeed, in the high crystallization temperature range, the crystal thickness analyzed by SAXS undergoes a sharp increase from a thickness corresponding to ˜ 3 repeating units to 4 repeating units (FIG. 8). A sharp increase in crystal thickness increases substantially the free energy barrier for nucleation leading to lower nucleation density and to spherulites that can grow up to large diameters as shown. There is no change in the FTIR or X-ray patterns in the temperature range of 80-90° C. where this major morphological change is observed.

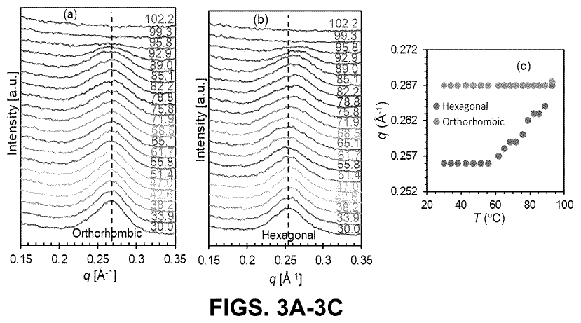

With focus on the low temperature polymorphic transformation of PE-2,18 from conformationally disordered hexagonal to orthorhombic-like crystals, we now analyze how that change affects the ester-ester crystalline layer periodicity of the lamellae from in-situ synchrotron X-ray patterns (0.15 Å⁻¹<q<0.35 Å⁻¹) collected on heating. For direct contrast, we analyzed specimens crystallized in the hexagonal (Q 0° C.) and in the orthorhombic (Q 75° C.) forms (FIGS. 3A and 3B). The observed peak scattering vectors correspond closely to the calculated all-trans length of the repeating unit (27.54 Å), confirming an ester-ester layered crystal structure. Moreover, at 30° C. the q of the hexagonal (q=0.256 Å⁻¹) is clearly lower than the value of the orthorhombic (q=0.268 Å⁻¹), indicating a slightly less tilt in chain packing (27° for hexagonal vs. 32° for orthorhombic) with respect to the surface normal. On heating (FIG. 3C), the scattering vector of the orthorhombic form is constant with increasing temperature, while q of the hexagonal starts to shift to higher values at ˜ 60° C., the temperature range where the hexagonal transforms to orthorhombic as shown by DSC and FTIR.

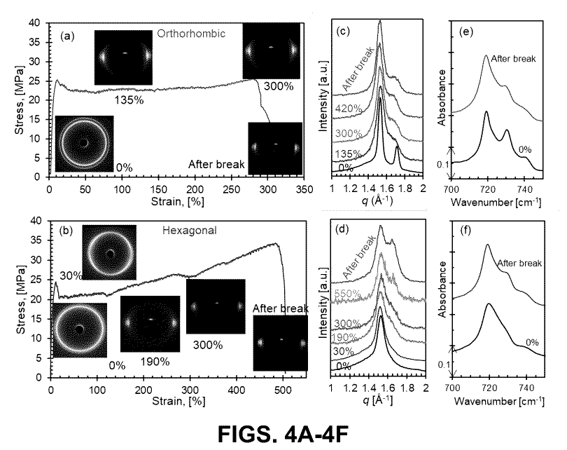

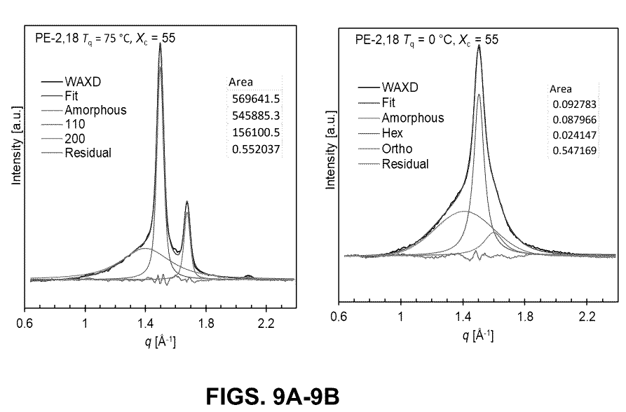

Although the level of crystallinities extracted from WAXD for PE-2,18 Q 75° C. and Q 25° C. specimens are about the same (FIGS. 9A-9B), the change in crystallographic phase from the all trans to a more conformationally disordered phase upon increasing rate of cooling impacts the mechanical performance of PE-2,18 under tensile deformation. The conformationally disordered hexagonal phase gives superior mechanical (stress-strain) properties than the more common orthorhombic phase. FIGS. 4A-4F display room temperature stress-strain deformation behavior and parallel 2D WAXD patterns collected in-situ during deformation of compression molded PE-2,18 specimens quenched from the melt to 75° C. (orthorhombic) and quenched to 25° C. (hexagonal). The average values of the main tensile properties are listed in Table 2. The yield stress is similar for both (˜ 25 MPa). However, a more defective staggering of the long CH₂ sequences in the hexagonal structure leads to lower Young's modulus, 410 MPa compared with 614 MPa for the orthorhombic, and to much higher strains. As shown, the elongation at break of the PE-2,18 in the hexagonal structure (470%) is almost double the value for the orthorhombic specimen (280%). The ultimate stress is higher, and of relevance is the enhanced strain-hardening of hexagonal samples compared with the deformation of the orthorhombic material.

TABLE 2
Tensile properties of PE-2,18 quenched from the melt to 25°
C. (hexagonal) and quenched to 75° C. (orthorhombic).

| | Degree of | | | Yield | Ultimate | Elongation | Strain- |
|---|---|---|---|---|---|---|---|
| Crystallization | crystallinity | Crystal | Modulus | stress | stress | at break | hardening* |
| conditions | (%) | structure | (MPa) | (MPa) | (MPa) | (%) | (MPa) |
| Quenched to | 55 | Hexagonal | 410 ± 16 | 25 ± 0.4 | 32 ± 4 | 469 ± 30 | 8 ± 4 |
| 25° C. | | | | | | | |
| Quenched to | 55 | Orthorhombic | 614 ± 108 | 22 ± 2.8 | 20 ± 4 | 280 | −2 ± 2 |
| 75° C. | | | | | | | |

*Difference between the yield stress and the ultimate tensile stress

The modulus, yield stress and elongation at break of the orthorhombic specimen are very similar to the values obtained for injection molded PE-2,18 specimens, also in the orthorhombic phase, studied in a previous work.²⁰ Conversely, the tensile behavior of fast-quenched hexagonal specimens differs substantially, especially with respect to the evolution of the initial structure during deformation. Specimens in the hexagonal phase have higher strain hardening than those in the orthorhombic phase (8 MPa±4 MPa vs −2 MPa±2 MPa, respectively). Additionally, specimens in the hexagon phase stretch to much larger deformations before breaking than those in the orthorhombic phase (469%+30% vs 280%, respectively). In both types, a well-oriented fiber-like structure develops shortly after yield, as shown by the appearance of equatorial spots (FIGS. 4A and 4B). Moreover, while the orthorhombic specimens maintain the same crystal structure during the whole deformation, at strains>200% the hexagonal phase transforms gradually to the orthorhombic type, as shown by the appearance of the reflection at q˜1.65 Å⁻¹ in the 1D patterns of FIGS. 4C and 4D obtained from integration of the equatorial lines. The shift to lower q and broadening of the (200) plane during deformation of both, hexagonal and orthorhombic (FIGS. 4C and 4D), is explained by the shearing of lamellae crystallites and residual strain during transformation. In polyethylenes, such a shift has been associated with strain of the “a” axis of the orthorhombic crystals during deformation.³⁴

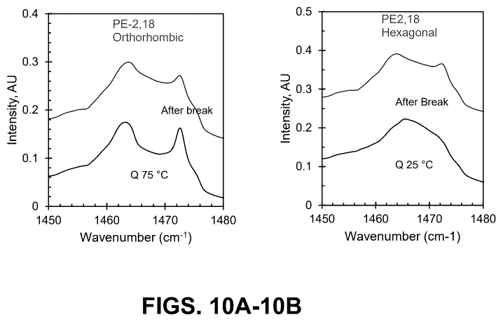

Comparing the FTIR spectra of the initial hexagonal specimen and after break (FIG. 4F), we find partial recovery of the 720 cm⁻¹ splitting and recovery of the two bending modes associated with the all-trans conformations in the oriented fibers (FIGS. 10A-10B), which strongly support the hexagonal-orthorhombic transformation during tensile deformation. Conversely, the splitting of the 720 cm⁻¹ band is maintained during deformation of the orthorhombic structure (FIG. 4E).

The persistence of the low q reflection in the meridian of the orthorhombic and hexagonal structures during the whole deformation indicates that the initial ester-ester layered crystal structure is maintained. Hence, at the unit cell level, the major change after yield is evolution toward maximizing the all-trans packing of the long CH₂ sequences. This feature and the obvious increase in strain hardening of the hexagonal sample, suggests that during the transformation dipolar ester-ester interactions between the diol units persist and it is the regions of staggered long sequences that absorb a significant energy used for the transformation toward the all-trans orthorhombic subcell structure. The exact conformational change, especially around the esters that flank the diol unit, if any, remains to be elucidated.

In summary, we find that bioderived and recyclable unbranched aliphatic polyesters, such as PE-2,18 develop hexagonal crystal structures upon quenching from the melt to temperatures<˜50° C., and orthorhombic-like packing at higher quenching temperatures, or after isothermal crystallization. The hexagonal crystals transform to the orthorhombic either on heating, or under tensile deformation. Films of PE-2,18 specimens with hexagonal packing and a thickness similar to those used for packaging applications (˜ 0.10 mm thick), display improved mechanical performance compared to films in the orthorhombic phase. We attribute this to the stretch-induced transformation from hexagonal to orthorhombic.

Although crystal-crystal stretch-induced transformations are often observed for polymorphic crystalline polymers, as recently reviewed,³⁵ the most common types are those where a stable ordered phase transforms during tensile deformation to a less stable, more defected one. Typical examples are the monoclinic to mesomorphic transformation in isotactic polypropylene or the transformation of a to β crystals in polybutylene adipate.³⁶⁻³⁹ Transformations during tensile deformation of a crystal to another form with increased stability as we found for PE-2,18 are less common, especially when the transformed phase is stable after deformation. Such transformation derives in enhanced strain hardening and represents a desired toughening mechanism for PE-2,18 films, similar to the toughening mechanism of the hexagonal (B) to monoclinic (a) transformation upon deformation of isotactic polypropylene.^{40,41}

It should be emphasized that the above-described embodiments of the present disclosure are merely possible examples of implementations and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

### REFERENCES

1 De Rosa, C.; Auriemma, F.; Di Girolamo, R.; Ruiz de Ballesteros, O. Crystallization of the Mesomorphic Form and Control of the Molecular Structure for Tailoring the Mechanical Properties of Isotactic Polypropylene. J. Polym. Sci., Polym. Phys. Ed. 2014, 52, 677-699,
2 Alamo, R. G.; Kim, M. H.; Galante, M. J.; Isasi, J. R.; Mandelkern, L. Structural and Kinetic Factors Governing the Formation of the Polymorph of Isotactic Polypropylene. Macromolecules 1999, 32, 4050-4064.
3 De Rosa, C.; Auriemma, F.; Ruiz de Ballesteros, O.; Esposito, F.; Laguzza, D.; Di Girolamo, R.; Resconi, L. Crystallization Properties and Polymorphic Behavior of Isotactic Poly(1-Butene) from Metallocene Catalysts: The Crystallization of Form I from the Melt. Macromolecules 2009, 42, 8286-8297.
4 Tashiro, K.; Hu, J.; Wang, H.; Hanesaka, M.; Alberto, S. Refinement of the Crystal Structures of Forms I and II of Isotactic Polybutene-1 and a Proposal of Phase Transition Mechanism between Them, Macromolecules, 2016, 49, 1392-1404.
5 Müller, A. An X-ray investigation of normal paraffins near their melting points. Proc. R. Soc. London, Ser. A, 1932, 138, 514-530.
6 Ewen, B.; Strobl, G. R.; Richter, D. Phase transitions in crystals of chain molecules. Relation between defect structures and molecular motion in the four modifications of n-C₃₃H₆₈. Faraday Discuss. Chem. Soc. 1980, 69, 19-31.
7. Tashiro, K.; Sasaki, S.; Kobayashi, M. Structural Investigation of Orthorhombic-to-Hexagonal Phase Transition in Polyethylene Crystal: The Experimental Confirmation of the Conformationally Disordered Structure by X-ray Diffraction and Infrared/Raman Spectroscopic Measurements. Macromolecules 1996, 29, 7460-7469.
8 Feng, S.; Lin, Y.; Yu, W.; Iqbal, O.; Habumugisha, J C.; Chen, W.; Meng, L.; Lu, A.; Li, L. Stretch-Induced Structural transition of Linear-Low Density Polyethylene during Uniaxial der Different Strain Rates. Polymer 2012, 226, 123795.
9 Simanke A. G.; Alamo, R. G.; Galland, G. B.; Mauler, R. S. Wide-Angle X-ray Scattering of Random Metallocene-Ethylene Copolymers with Different Types and Concentration of Comonomer. Macromolecules 2001, 34, 6959-6971.
10 Bassett, D. C.; Khalifa, B. A.; Turner, B. Chain-extended Crystallization of Polyethylene. Nature 1972, 239, 106-108.
11 Bassett, D. C.; Block, S.; Piermarini, G. J. A high-pressure phase of polyethylene and chain-extended growth. Journal of Applied Physics 1974, 45, 4146-4150.
12 Yamamoto, T. Nature of disorder in the high-pressure phase of polyethylene. J. Macrom. Sci. Phys. 1979, B16, 487.
13 Rastogi, S.; Hikosaka, M.; Kawabata, H.; Keller, A. Role of mobile phases in the crystallization of polyethylene. Part 1. Metastability and lateral growth. Macromolecules 1991, 24, 6384-6391.
14 Broadhurst, M. G. An Analysis of the Solid Phase Behavior of the Normal Paraffins, J. Res. Natl. Bur. Stand., Sect. A, 1962, 66, 241-249.
15 Ungar, G. Structure of Rotator Phases in n-Alkanes. J. Phys. Chem. 1083, 87, 689-695.
16 Vaughan, A. S.; Ungar, G.; Bassett, D. C.; Keller, A. On Hexagonal Phases of Paraffins and Polyethylenes, Polymer, 1985, 26, 726-732
17 De Rosa, C.; Auriemma, F. The Deformability of Polymers: The Role of Disordered Mesomorphic Crystals and Stress-Induced Phase Transformations. Angewandte Chem. 2012, 51, 1207-1211.
18 Kaner, P.; Ruiz-Orta, C.; Boz, E.; Wagener, K. B.; Tasaki, M.; Tashiro, K.; Alamo, R. G. Kinetic Control of Chlorine Packing in Crystals of a Precisely Substituted Polyethylene. Toward Advanced Polyolefin Materials. Macromolecules 2014, 47, 236-245.
19 Häußler, M.; Eck, M.; Rothauer, D.; Mecking, S. Closed-Loop Recycling of Polyethylene-like Materials. Nature 2021, 590 (7846), 423-427.
20 Eck, M.; Schwab, M.; Nelson, S. T.; Wurst, T. F.; K.; Iberl, S.; Schleheck, D.; Link, C.; Battagliarin, G.; Mecking, S. Biodegradable High-Density Polyethylene-like Material, Angew. Chemie Int. Ed. 2023, 62, e2022134.
21 Nomura, K.; Binti Awang N. W. Synthesis of Bio-Based Aliphatic Polyesters from Plant Oils by Efficient Molecular Catalysis: A Selected Survey from Recent Reports, ACS Sustain. Chem. Eng. 2021, 9, 5486-5505.
22 Santonja-Blasco, L.; Zhang, X.; Alamo, R. G. Crystallization of Precision Ethylene Copolymers. In Advances in Polymer Science; 2015; Vol. 276, pp 133-182.
23 Yan, L.; Bustillo, K. C.; Panova, O.; Minor, A. M.; Winey, K. I. Solution-Grown Crystals of Precise Acid- and Ion-Containing Polyethylenes. Polymer 2018, 135, 111-119.
24 Zhang, X.; Zuo, X.; Ortmann, P.; Mecking, S.; Alamo, R. G. Crystallization of Long-Spaced Precision Polyacetals I: Melting and Recrystallization of Rapidly Formed Crystallites. Macromolecules 2019, 52 (13), 4934-4948.
25 Zhang, X.; Marxsen, S. F.; Ortmann, P.; Mecking, S.; Alamo, R. G. Crystallization of Long-Spaced Precision Polyacetals II: Effect of Polymorphism on Isothermal Crystallization Kinetics. Macromolecules 2020, 53 (18), 7899-7913.
26 Sun, C.; Ma, X.; Ni, L.; Ding, M.; Xia, J.; Zheng, Y.; Yu, C.; Wang, B.; Pan, P. Hexagonal Phase Formation and Crystalline Structural Transition in Long-Spaced Aliphatic Polyesters with Side Groups. ACS Macro Lett., 2023, 12, 1324-1330.
27 Kim, E.; Uyama, H.; Doi, Y.; Ha, C.; Iwata, T. Crystal Structure and Morphology of Poly(16-hexadecalactone) Chain-folded Lamellar Crystals. Macromol. Biosci. 2005, 5, 734-742
28 Gazzano, M.; Malta, V.; Focarete, M. L.; Scandola, M.; Gross, R. A. Crystal Structure of Poly(ω-pentadecalactone). J. Polym. Sci. Part B: Polym. Phys. 2003, 41, 1009-1013.
29 Marxsen, S. F.; Häußler, M.; Mecking, S.; Alamo, R. G. Unlayered-Layered Crystal Transition in Recyclable Long-Spaced Aliphatic Polyesters, ACS Appl. Polym. Mater. 2021, 3, 5243-5256.
30 Marxsen, S. F.; Eck, M.; Häußler, M.; Mecking, S.; Alamo, R. G. Effect of CH₂ Run Length on the Crystallization Kinetics of Sustainable Long-Spaced Aliphatic Polyesters. Polymer 2023, 282, 126181.
31 Marxsen, S. F.; Song, D.; Zhang, X.; Flores, I.; Fernández, J.; Sarasua, J. R.; Müller, A. J.; Alamo, R. G. Crystallization Rate Minima of Poly(ethylene brassylate) at Temperatures Transitioning between Quantized Crystal Thicknesses, Macromolecules 2022, 55, 3958-3973.
32 Zhou, L.; Qin, P.; Wu.; Li, B. G.; Dubois, P. Potentially Biodegradable “Short-Long” Type Diol-Diacid Polyesters with Superior Crystallizability, Tensile Modulus, and Water Vapor Barrier, ACS Sustain. Chem. Eng. 2021, 9, 17362-17370.
33 Zerbi, G.; Magni, R.; Gusoni, M.; Holland Moritz, K.; Bigotto, A.; Dirlikov, S. Molecular mechanics for phase transition and melting of n-alkanes: A spectroscopic study of molecular mobility of solid n-nonadecane. J. Chem. Phys., 1981, 75, 3175-3194.
34 Tashiro, K., Structural Science of Crystalline Polymers: Basic Concepts and Practices. Springer, Singapore 2022, Chapter 1, pg. 253.
35 Xu, S.; Zhou J.; Pan P. Strain-induced multiscale structural evolutions of crystallized polymers: From fundamental studies to recent progresses. Progress in Polymer Science 2023, 140, 101676.
36 Auriemma, F.; De Rosa, C. Stretching isotactic polypropylene: From “cross-β” to crosshatches, from γ form to α form. Macromolecules 2006, 39, 7635-7647.
37 Zuo, F.; Keum, J.; Chen, X.; Hsiao, B.; Chen, H.; Lai, S. Y.; Wevers, R.; Li, J. The role of interlamellar chain entanglement in deformation-induced structure changes during uniaxial stretching of isotactic polypropylene. Polymer 2007, 48, 6867-6880.
38 Ma, Z.; Shao, C.; Wang, X.; Zhao, B.; Li, X.; An, H.; Yan, T.; Li, Z.; Li, L. Critical stress for drawing-induced a crystal-mesophase transition in isotactic polypropylene. Polymer 2009, 50, 2706-2715.
39 Song, Y. Y.; Ye, H. M.; Xu, J.; Hou, K.; Zhou, Q.; Lu, G. W. Stretch-induced bidirectional polymorphic transformation of crystals in poly(butylene adipate). Polymer 2014, 55, 3054-3061.
40 Bao, R. Y.; Ding, Z. T.; Liu, Z. Y.; Yang, W.; Xie, B. H.; Yang, M. B. Deformation-induced structure evolution of oriented β-polypropylene during uniaxial stretching. Polymer 2013, 54, 1259-1268.
41 Zhang, C.; Liu, G.; Song, Y.; Zhao, Y.; Wang, D. Structural evolution of β-iPP during uniaxial stretching studied by in-situ WAXS and SAXS. Polymer, 2014, 55, 6915-6923.
42 Snyder, R. G. Vibrational Spectra of Crystalline N-Paraffins: Part I. Methylene Rocking and Wagging Modes. J. Mol. Spectrosc. 1960, 4, 411-434.
43 Snyder, R. G.; Schachtschneider, J. H. Vibrational Analysis of the N-paraffins-I: Assignments of Infrared Bands in the Spectra of C₃H₈ through N—C₁₉H₄₀. Spectrochim. Acta 1963, 19, 85-116.
44 Zhang, X.; Santonja-Blasco, L.; Wagener, K. B.; Boz, E.; Tasaki, M.; Tashiro, K.; Alamo, R. G. Infrared Spectroscopy and X-Ray Diffraction Characterization of Dimorphic Crystalline Structures of Polyethylenes with Halogens Placed at Equal Distance along the Backbone. J. Phys. Chem. B 2017, 121, 10166-10179.

1. A polyalkylene-based polyester comprising the repeat units having the structure I 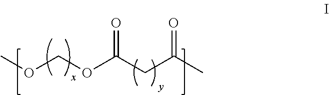
wherein
x is 2 or 3, and y is an integer greater than 10;
the polyalkylene-based polyester has a number average molecular weight greater than 30 kg/mol; and
the polyalkylene-based polyester is crystallized in hexagonal crystal form.

2. The polyalkylene-based polyester of claim 1, wherein the polyalkylene-based polyester is produced by the method comprising
(a) preparing the polyalkylene-based polyester in a melt state, and
(b) cooling the polyalkylene-based polyester in the melt state at a rate of greater than 80° C. per minute to a temperature below 60° C.

3. The polyalkylene-based polyester of claim 2, wherein preparing the polyalkylene-based polyester in a melt state comprises heating the polyalkylene-based polyester to from about 30° C. to about 40° C. above the melting point of the polyalkylene-based polyester.

4. The polyalkylene-based polyester of claim 2, wherein the polyalkylene-based polyester in the melt state is cooled at a rate of greater than 80° C. per minute to about 500° C. per minute.

5. The polyalkylene-based polyester of claim 2, wherein the polyalkylene-based polyester in the melt state is cooled to a temperature of less than about 60° C.

6. The polyalkylene-based polyester of claim 2, wherein the polyalkylene-based polyester in the melt state is cooled to a temperature of from about 0° C. to about 60° C.

7. The polyalkylene-based polyester of claim 1, wherein y is an integer from 12 to 50.

8. The polyalkylene-based polyester of claim 1, wherein y is 16.

9. The polyalkylene-based polyester of claim 1, wherein the polyalkylene-based polyester has a number average molecular weight of about 30 kg/mol to about 500 kg/mol.

10. The polyalkylene-based polyester of claim 1, wherein the crystallized polyalkylene-based polyester has a degree of crystallinity of about 40% to about 90%.

11. The polyalkylene-based polyester of claim 1, wherein the crystallized polyalkylene-based polyester has an elastic modulus of about 350 MPa to about 800 MPa.

12. The polyalkylene-based polyester of claim 1, wherein the crystallized polyalkylene-based polyester has a yield stress of about 20 MPa to about 35 MPa.

13. The polyalkylene-based polyester of claim 1, wherein the crystallized polyalkylene-based polyester has an ultimate stress at break of about 30 MPa to about 40 MPa.

14. The polyalkylene-based polyester of claim 1, wherein the crystallized polyalkylene-based polyester has a strain-hardness of about 5 MPa to about 20 MPa.

15. The polyalkylene-based polyester of claim 1, wherein the crystallized polyalkylene-based polyester has an elongation at break from about 400% to about 600%

16. A film or membrane comprising the polyalkylene-based polyester of claim 1.

17. The film or membrane of claim 16, wherein the film is a component of an article.

18. An article comprising the polyalkylene-based polyester of claim 1.

19. The article of claim 18, wherein the article is a plastic used in packaging goods.

20. The article of claim 22, wherein the plastic is a plastic bag, plastic wrap, single-use plastic, non-woven fabrics, single-layer packaging plastic, or multi-layer packaging plastic.
